(19) United States
(12) Patent Application Publication
(10) Pub. No.: US 2024/0205442 A1
(43) Pub. Date: Jun. 20, 2024

(54) IMAGE DECODING DEVICE, IMAGE-DECODING METHOD, AND PROGRAM

(71) Applicant: KDDI CORPORATION, Tokyo (JP)

(72) Inventors: Haruhisa KATO, Fujimino-shi (JP); Yoshitaka KIDANI, Fujimino-shi (JP)

(73) Assignee: KDDI CORPORATION, Tokyo (JP)

(21) Appl. No.: 18/591,633

(22) Filed: Feb. 29, 2024

Related U.S. Application Data
(63) Continuation of application No. PCT/JP2023/008633, filed on Mar. 7, 2023.

(30) Foreign Application Priority Data
Apr. 12, 2022 (JP) 2022-065690

(51) Int. Cl. H04N 19/44; H04N 19/105; H04N 19/119; H04N 19/124; H04N 19/132; H04N 19/139; H04N 19/159; H04N 19/176; H04N 19/18; H04N 19/463; H04N 19/61

(52) U.S. Cl. CPC H04N 19/44; H04N 19/105; H04N 19/119; H04N 19/124; H04N 19/132; H04N 19/139; H04N 19/159; H04N 19/176; H04N 19/18; H04N 19/463; H04N 19/61

(57) ABSTRACT

In an image decoding device (200) according to the present invention, a circuit: decodes control information and a quantized value; obtains a decoded transform coefficient by performing inverse quantization on the decoded quantized value; obtains a decoded prediction residual by performing inverse transform on the decoded transform coefficient; generates a first predicted sample based on a decoded sample and the decoded control information; accumulates the decoded sample; generates a second predicted sample based on the accumulated decoded sample and the decoded control information; generates a third predicted sample by weighted averaging using weighting coefficients which are uniquely selected from among a plurality of weighting coefficients based on indirect control information for at least one of the first predicted sample or the second predicted sample; and obtains the decoded sample by adding the decoded prediction residual and the third predicted sample.

### CROSS-REFERENCE TO RELATED APPLICATIONS

The present application is a continuation of PCT Application No. PCT/JP2023/008633, filed on Mar. 7, 2023, which claims the benefit of Japanese patent application No. 2022-065690 filed on Apr. 12, 2022, the entire contents of which are incorporated herein by reference in its entirety.

### TECHNICAL FIELD

The present invention relates to an image decoding device, an image decoding method, and a program.

### BACKGROUND ART

Non Patent Literature 1 and Non Patent Literature 2 disclose a geometric partitioning mode (GPM).

The GPM is a mode in which a rectangular block is obliquely divided into two areas and each area is subjected to motion compensation processing. Specifically, the divided two areas are subjected to motion compensation processing using merge vectors, are subjected to weighted averaging processing, and are thus blended.

### CITATION LIST

### Non Patent Literature

Non Patent Literature 1: ITU-T H. 266 VVC
Non Patent Literature 2: CE4: Summary report on inter prediction with geometric partitioning, JVET-Q0024

### SUMMARY OF THE INVENTION

However, in the techniques disclosed Non Patent Literature 1 and Non Patent Literature 2, a weighted averaging pattern is limited, and hence there has been a problem that there is room for improvement in encoding performance.

Thus, the present invention has been made in view of the above-described problem, and an object of the present invention is to provide an image decoding device, an image decoding method, and a program capable of further improving encoding efficiency in GPM.

The first aspect of the present invention is summarized as an image decoding device including a circuit, wherein the circuit: decodes control information and a quantized value; obtains a decoded transform coefficient by performing inverse quantization on the decoded quantized value; obtains a decoded prediction residual by performing inverse transform on the decoded transform coefficient; generates a first predicted sample based on a decoded sample and the decoded control information; accumulates the decoded sample; generates a second predicted sample based on the accumulated decoded sample and the decoded control information; generates a third predicted sample by weighted averaging using weighting coefficients which are uniquely selected from among a plurality of weighting coefficients based on indirect control information for at least one of the first predicted sample or the second predicted sample; and obtains the decoded sample by adding the decoded prediction residual and the third predicted sample.

The second aspect of the present invention is summarized as an image decoding method including: decoding control information and a quantized value; obtaining a decoded transform coefficient by performing inverse quantization on the decoded quantized value; obtaining a decoded prediction residual by performing inverse transform on the decoded transform coefficient; generating a first predicted sample based on a decoded sample and the decoded control information; accumulating the decoded sample; generating a second predicted sample based on the accumulated decoded sample and the decoded control information; generating a third predicted sample by weighted averaging using weighting coefficients which are uniquely selected from among a plurality of weighting coefficients based on indirect control information for at least one of the first predicted sample or the second predicted sample; and obtaining the decoded sample by adding the decoded prediction residual and the third predicted sample.

The third aspect of the present invention is summarized as a program stored on a non-transitory computer-readable medium for causing a computer to function as an image decoding device including a circuit, wherein the circuit: decodes control information and a quantized value; obtains a decoded transform coefficients by performing inverse quantization on the decoded quantized value; obtains a decoded prediction residual by performing inverse transform on the decoded transform coefficient; generates a first predicted sample based on a decoded sample and the decoded control information; accumulates the decoded sample; generates a second predicted sample based on the accumulated decoded sample and the decoded control information; generates a third predicted sample by weighted averaging using weighting coefficients which are uniquely selected from among a plurality of weighting coefficients based on indirect control information for at least one of the first predicted sample or the second predicted sample; and obtains the decoded sample by adding the decoded prediction residual and the third predicted sample.

According to the present invention, it is possible to provide an image decoding device, an image decoding method, and a program capable of further improving encoding efficiency in GPM.

### BRIEF DESCRIPTION OF THE DRAWINGS

FIG. 1 is a diagram illustrating an example of functional blocks of an image decoding device 200 according to an embodiment.

FIG. 2 is a diagram illustrating an example of a case where a rectangular unit block is divided into two areas of a small area A and a small area B by a division boundary.

FIG. 3 is a diagram illustrating an example of three patterns of weighting coefficients allocated to the division boundary of the small area B illustrated in FIG. 2.

FIG. 4 is a diagram illustrating an example in which weighting coefficients w of a pattern (2) are applied to an 8×8 block.

FIG. 5 is a diagram illustrating an example in which weighting coefficients w of a pattern (1) are applied to an 8×8 block.

FIG. 6 is a diagram illustrating an example in which weighting coefficients w of a pattern (3) are applied to an 8×8 block.

FIG. 7 is a flowchart illustrating an example of processing of setting weighting coefficients by a blending unit 207 according to a first embodiment.

FIG. 8 is a flowchart illustrating an example of processing of setting weighting coefficients by the blending unit 207 according to a second embodiment.

FIG. 9 is a diagram for explaining the second embodiment.

FIG. 10 is a diagram for explaining the second embodiment.

FIG. 11 is a flowchart for explaining an example of processing of setting weighting coefficients by the blending unit 207 according to a third embodiment.

FIG. 12 is a diagram for explaining an example in which weighting coefficients are defined based on a distance from a division boundary.

### DESCRIPTION OF EMBODIMENTS

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

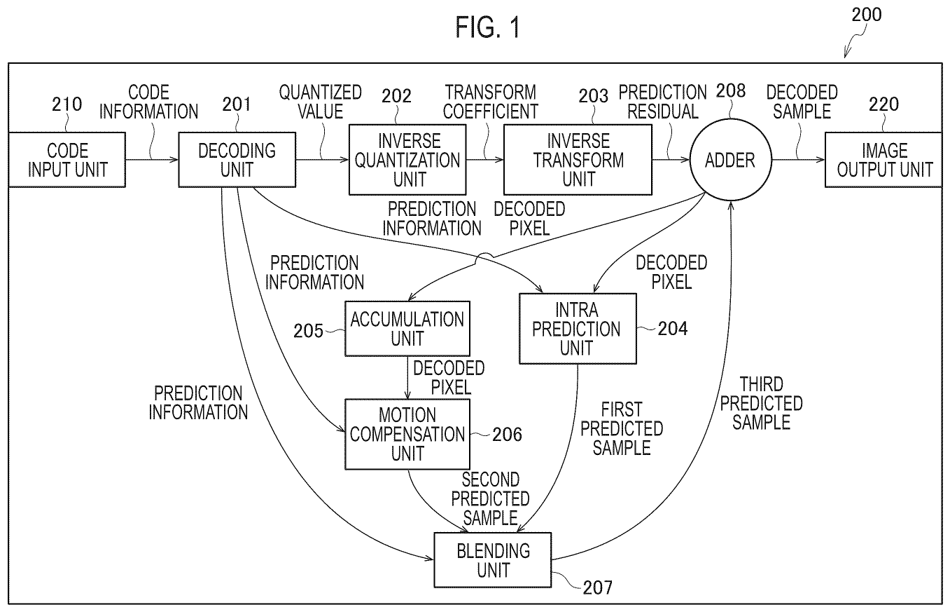

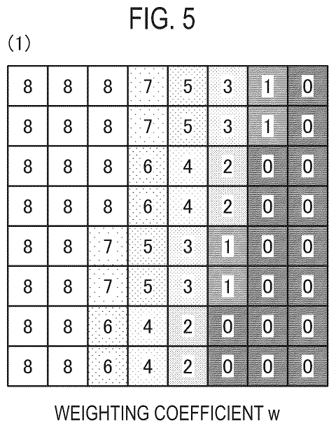

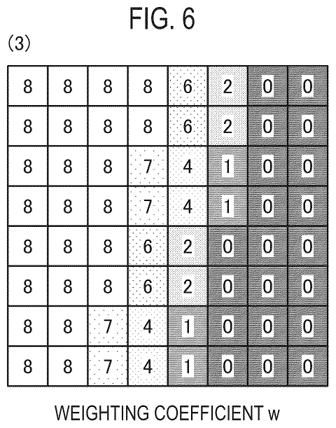

Hereinbelow, an image decoding device 200 according to a first embodiment of the present invention is described with reference to FIGS. 1 to 7. FIG. 1 is a diagram illustrating an example of functional blocks of the image decoding device 200 according to the present embodiment.

As illustrated in FIG. 1, an image decoding device 200 includes a code input unit 210, a decoding unit 201, an inverse quantization unit 202, an inverse transform unit 203, an intra prediction unit 204, an accumulation unit 205, a motion compensation unit 206, a blending unit 207, an adder 208, and an image output unit 220.

The code input unit 210 is configured to acquire encoded information which is encoded by an image encoding device.

The decoding unit 201 is configured to decode control information and a quantized value from the encoded information which is input from the code input unit 210. For example, the decoding unit 201 is configured to output control information and a quantized value by performing variable length decoding on the encoded information.

Here, the quantized value is transmitted to the inverse quantization unit 202, and the control information is transmitted to the motion compensation unit 206, the intra prediction unit 204, and the blending unit 207. Note that the control information includes information required for control of the motion compensation unit 206, the intra prediction unit 204, the blending unit 207, and the like, and may include header information such as a sequence parameter set, a picture parameter set, a picture header, or a slice header.

The inverse quantization unit 202 is configured to obtain a decoded transform coefficient by performing inverse quantization on the quantized value transmitted from the decoding unit 201. The transform coefficient is transmitted to the inverse transform unit 203.

The inverse transform unit 203 is configured to obtain a decoded prediction residual by performing inverse transform on the transform coefficient transmitted from the inverse quantization unit 202. The prediction residual is transmitted to the adder 208.

The intra prediction unit 204 is configured to generate a first predicted sample based on a decoded sample and the control information transmitted from the decoding unit 201. Here, the decoded sample is obtained via the adder 208, and is accumulated in the accumulation unit 205. Further, the first predicted sample is a predicted sample as an approximate value of an input sample in a small area which is set by the blending unit 207. Note that the first predicted sample is transmitted to the blending unit 207.

The accumulation unit 205 is configured to cumulatively accumulate the decoded samples transmitted from the adder 208. The decoded sample is referred to from the motion compensation unit 206 via the accumulation unit 205.

The motion compensation unit 206 is configured to generate a second predicted sample based on the decoded samples which are accumulated in the accumulation unit 205 and the control information which is transmitted from decoding unit 201. Here, the second predicted sample is a predicted sample as an approximate value of an input sample in a small area which is set by the blending unit 207. Note that the second predicted sample is transmitted to the blending unit 207.

The adder 208 is configured to obtain a decoded sample by adding the prediction residual transmitted from the inverse transform unit 203 and a third predicted sample transmitted from the blending unit 207. The decoded sample is transmitted to the image output unit 220, the accumulation unit 205, and the intra prediction unit 204.

The blending unit 207 is configured to generate a third predicted sample by preparing a plurality of weighting coefficients by which a width of a division boundary is different for at least one of the first predicted sample transmitted from the intra prediction unit 204 or the second predicted sample transmitted from the motion compensation unit 206 and controlling the width of the division boundary by weighted averaging.

A role of the blending unit 207 is to, in order to compensate for a decoding target block with high accuracy in the adder 208 in a subsequent stage, select weighting coefficients for a plurality of predicted samples that are most suitable for the decoding target block and blend the plurality of input predicted samples according to the weighting coefficients.

Any division mode can be used as long as the decoding target block is divided into a plurality of small areas in the division mode. In the following description, a case of using a geometric partitioning mode (GPM) disclosed in Non Patent Literature 1 and Non Patent Literature 2 as an example of the division mode will be described.

For the weighting coefficients, a plurality of patterns in which arbitrary values are set in advance for each sample of the unit block are prepared, and any one of the patterns is applied. That is, the blending unit 207 may be configured to select and apply one of a plurality of weighting coefficients.

According to the configuration, by preparing a lookup table or the like in which a plurality of weighting coefficients is set, the blending unit 207 does not need to calculate the weighting coefficients every time.

A total value of the weighting coefficients for the plurality of predicted samples is designed to be 1 for each sample, and a result obtained by blending the plurality of predicted samples by weighted averaging using the weighting coefficients is set as a predicted sample by the blending unit 207.

The sample having the weighting coefficient of 1 (that is, the maximum value) is adopted as the input predicted sample, and the sample having the weighting coefficient of 0 (that is, the minimum value) is not used as the input predicted sample. Thus, conceptually, this operation corresponds to dividing a unit block into a plurality of small areas, and determines which sample of the plurality of input predicted samples is applied at which ratio and where.

Here, distribution of the weighting coefficients can be expressed by a smaller unit block when the distribution is a rectangular shape distribution such as a bisector. Thus, it is desirable to distribute the weighting coefficients in a non-rectangular shape.

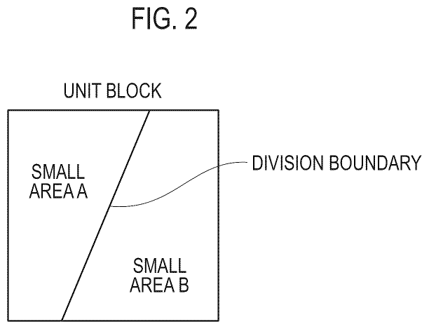

In the example of FIG. 2, an example of a case where the unit blocks are distributed in an oblique shape is illustrated. In the example of FIG. 2, a rectangular unit block is divided into two areas of a small area A and a small area B by a division boundary.

In each of the small areas A and B, a predicted sample is generated by an arbitrary method such as intra prediction or motion compensation.

At this time, even in a case where the division shape is determined, when the weighting coefficient near the division boundary is determined, it is not possible to express a diversity of the division boundary. As a result, there is a problem that the encoding efficiency cannot be improved.

For example, in a case where the small area is an area in which vigorous movement is present, blurring occurs when imaging. Thus, it is desirable to blur a plurality of small areas over a wide area and perform weighted averaging on the division boundary.

On the other hand, in a case where the small area is an artificially edited area such as a caption, blurring does not occur. Thus, it is desirable to perform weighted averaging such that the division boundary is limited to a narrow area and only a plurality of small areas is adjacent to each other.

In order to solve this problem, in the present embodiment, a procedure of preparing and selecting a plurality of weighting coefficients by which a width of the division boundary of the small areas is different is taken.

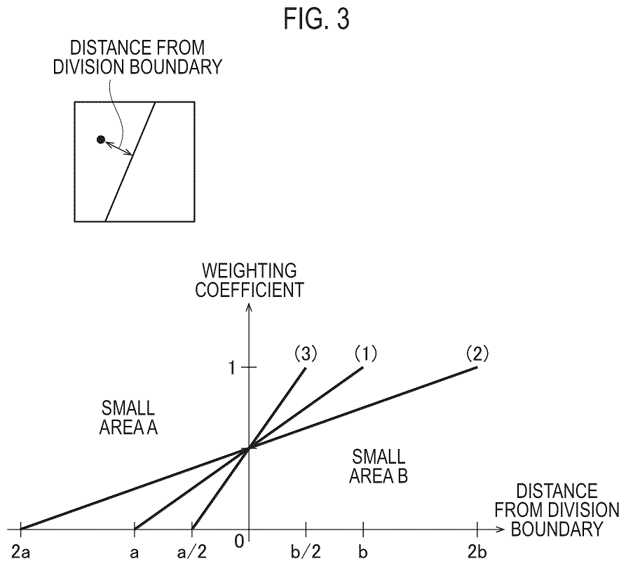

FIG. 3 illustrates an example of three patterns of weighting coefficients allocated to the division boundary of the small area B illustrated in FIG. 2. In FIG. 3, a horizontal axis represents a distance in units of samples from a position of the division boundary, and a vertical axis represents the weighting coefficient.

Specifically, there are prepared a pattern (1) in which a weighting coefficient [0, 1] is allocated to a range of [a, b] for the distances a and b in units of samples from a position of the division boundary which is set in advance, a pattern (2) in which a weighting coefficient [0, 1] is similarly allocated to a range of [2a, 2b] obtained by respectively doubling the distances a and b, and a pattern (3) in which a weighting coefficient [0, 1] is similarly allocated to a range of [a/2, b/2] obtained by respectively multiplying the distances a and b by ½.

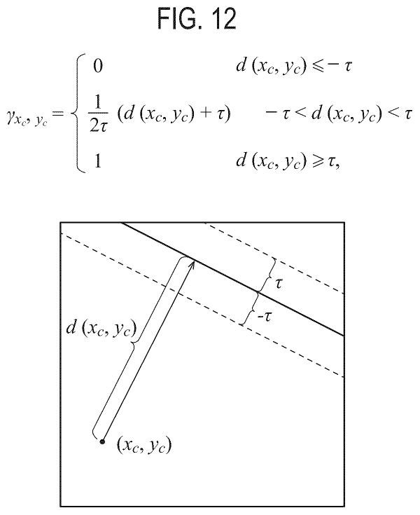

As illustrated in FIG. 12, in a case where the weighting coefficient is defined as γ_{xc,yc} which is uniquely determined by a distance d (xc, yc) from the division boundary (a black solid line), preparing the patterns is equivalent to preparing a plurality of patterns (variable values), instead of a limited pattern (fixed value), for the width of the division boundary of the small areas in FIG. 12, that is, the width t when the weighting coefficient has a value other than a minimum value or a maximum value. Here, xc, yc is a coordinate in the decoding target block.

That is, the blending unit 207 may be configured to set a plurality of weighting coefficients according to the inter-sample distance from the division boundary.

According to the configuration, it is possible to make the width of the boundary variable in proportion to the distance from the division boundary, and to achieve an effect of minimizing a change from the calculation expression in the related art illustrated in FIG. 12.

Note that, when a=b, symmetrical weighting coefficients with respect to the division boundary may be set. That is, the blending unit 207 may be configured to set, as the weighting coefficients, symmetrical weighting coefficients with respect to the division boundary. According to the configuration, b is unnecessary, and thus a code amount can be reduced.

In addition, when a≠b, asymmetrical weighting coefficients with respect to the division boundary may be set. That is, the blending unit 207 may be configured to set, as the weighting coefficients, asymmetrical weighting coefficients with respect to the division boundary. According to the configuration, in a case where there are different blurring states on both sides of the boundary, it is possible to perform prediction with high accuracy.

In addition, the number is not limited to the two of a and b, and the weighting coefficients can be set using a plurality of line segments or the like by increasing the number. That is, the blending unit 207 may be configured to set the weighting coefficients using a plurality of line segments according to the inter-sample distance from the division boundary. According to the configuration, it is possible to perform prediction with high accuracy in a case where blurring occurs in a nonlinear manner.

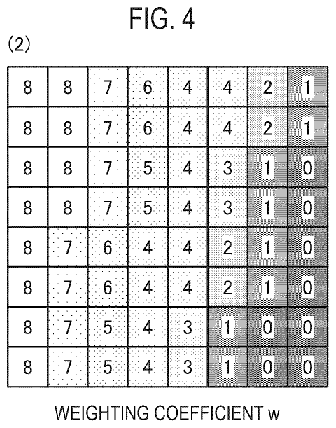

FIG. 4 to FIG. 6 illustrate an example in which each weighting coefficient w is applied to an 8×8 block. The weighting coefficient w in FIG. 4 to FIG. 6 takes a value of 0 to 8, and is blended by the following expression.

(w×small area A+(8−w)×small area B+4)>>3

As described above, by setting the plurality of weighting coefficients w according to the inter-sample distance from the division boundary, an effect that can be uniformly derived even in various block sizes such as 8×8 and 64×16 can be obtained. The type, the shape, and the number of patterns can be arbitrarily set. For example, in the above description, two times and ½ times the distances a and b have been described as the plurality of patterns. On the other hand, four times and ¼ times the distances may be used. Further, in the above expression, the weighting coefficient is set to a value of 0 to 8. On the other hand, the weighting coefficient may be set to another value such as a value of 0 to 16 or a value of 0 to 32. In particular, in a case where the inter-sample distance from the division boundary is twice or four times, weighted averaging in units of samples can be performed with high accuracy by increasing the maximum value of the weighting coefficient.

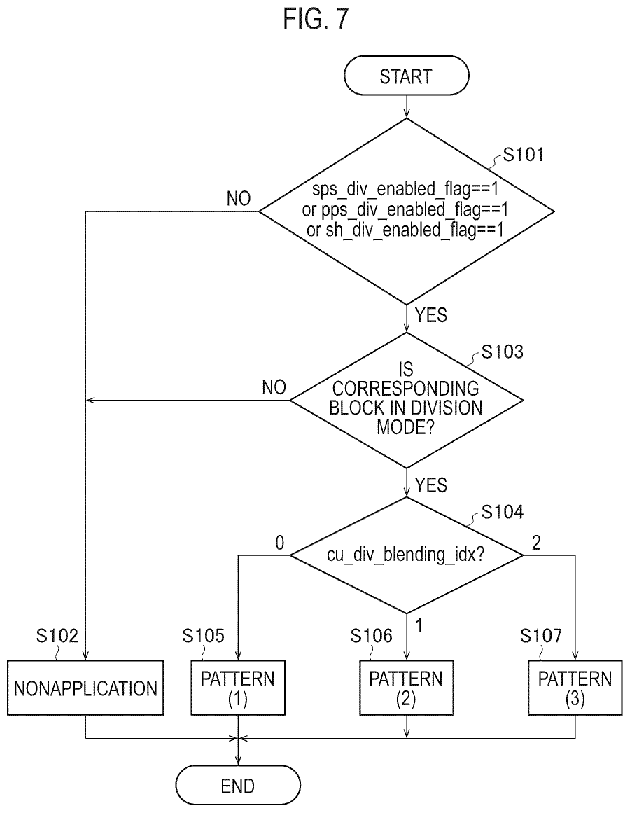

Hereinafter, an example of processing of setting the weighting coefficients by the blending unit 207 will be described with reference to FIG. 7.

As illustrated in FIG. 7, in step S101, the blending unit 207 determines whether or not any of sps_div_enabled_flag, pps_div_enabled_flag, and sh_div_enabled_flag included in the control information is 1. In a case of No (in a case where none of the flags is 1), the processing proceeds to step S102, and in a case of Yes, the processing proceeds to step S103.

In step S102, the blending unit 207 does not apply weighted averaging using the weighting coefficients to the decoding target block.

In step S103, the blending unit 207 determines whether or not GPM is applied to the decoding target block. In a case of No, the processing proceeds to step S102, and in a case of Yes, the processing proceeds to step S104.

In step S104, the blending unit 207 decodes cu_div_blending_idx included in the control information.

In a case where cu_div_blending_idx is 0, the operation proceeds to step S105. In a case where cu_div_blending_idx is 1, the operation proceeds to step S106. In a case where cu_div_blending_idx is 2, the operation proceeds to step S107.

In step S105, the blending unit 207 selects and applies, as the weighting coefficients, the weighting coefficients of the pattern (1) from among the patterns (1) to (3).

In step S106, the blending unit 207 selects and applies, as the weighting coefficients, the weighting coefficients of the pattern (2) from among the patterns (1) to (3).

In step S107, the blending unit 207 selects and applies, as the weighting coefficients, the weighting coefficients of the pattern (3) from among the patterns (1) to (3).

Note that, in a case where a chrominance sample component of the decoding target block is not down-sampled with respect to a luminance component of the decoding target block, the blending unit 207 may be configured to use a weighting coefficient that determines a width of the division boundary derived from the luminance component of the decoding target block, as a weighting coefficient that determines a width of the division boundary of the chrominance component of the decoding target block. According to the configuration, processing of deriving the weighting coefficient of the chrominance component of the decoding target block can be reduced.

Further, in a case where a chrominance component of the decoding target block is not down-sampled with respect to a luminance component of the decoding target block, the blending unit 207 may be configured to derive a weighting coefficient that determines a width of the division boundary of the chrominance component of the decoding target block by using, for example, a method similar to the method described above, instead of directly using, as a weighting coefficient that determines a width of the division boundary of the chrominance component of the decoding target block, a weighting coefficient that determines a width of the division boundary derived from the luminance component of the decoding target block. According to the configuration, the weighting coefficient of the chrominance component of the decoding target block can be independently derived, and thus an effect of improving encoding performance can be expected.

On the other hand, in a case where the chrominance component of the decoding target block is down-sampled with respect to the luminance component of the decoding target block, the blending unit 207 may derive a weighting coefficient that determines a width of the division boundary of the chrominance component of the decoding target block from a width of the division boundary of the luminance component of the decoding target block in consideration of the down-sampling method. According to the configuration, a similar effect obtained by the luminance component of the decoding target block can be obtained for the chrominance component of the decoding target block to be down-sampled.

Further, in a case where the blending unit 207 uses the control information such as the header to determine the width of the division boundary of the luminance component of the decoding target block, the operation is not necessary for the chrominance component of the decoding target block. Thus, an effect of improving encoding performance can be expected.

For example, in a case where the chrominance component of the decoding target block is down-sampled to half in both the horizontal direction and the vertical direction with respect to the luminance component of the decoding target block, the blending unit 207 may derive, as a weighting coefficient that determines a width of the division boundary of the chrominance component of the decoding target block, a weighting coefficient that determines a width of the division boundary which is half the width of the division boundary derived from the luminance component of the decoding target block.

For example, in a case where the chrominance component of the decoding target block is down-sampled to half in any one of the horizontal direction and the vertical direction with respect to the luminance component of the decoding target block, the blending unit 207 may derive, as a weighting coefficient that determines a width of the division boundary of the chrominance component of the decoding target block, a weighting coefficient that determines a width of the division boundary which is equal to or half the width of the division boundary derived from the luminance component of the decoding target block.

### Second Embodiment

Hereinafter, with reference to FIG. 3 and FIG. 8 to FIG. 10, a second embodiment of the present invention will be described focusing on differences from the first embodiment.

In the present embodiment, a code length is reduced by specifying a pattern of the weighting coefficients while eliminating a need for direct control information.

Therefore, in the present embodiment, the blending unit 207 is configured to generate the third predicted sample for at least one of the first predicted sample and the second predicted sample by weighted averaging using weighting coefficients which are uniquely selected from among the plurality of weighting coefficients based on the indirect control information.

That is, in the present embodiment, the blending unit 207 is configured to select (uniquely specify) the weighting coefficients from among the plurality of weighting coefficients according to the indirect control information.

Here, the blending unit 207 may be configured to prepare a plurality of weighting coefficients by which a width of the division boundary of the small areas is different and select the weighting coefficients from among the plurality of weighting coefficients.

Specifically, the blending unit 207 may be configured to select the weighting coefficients from among the plurality of weighting coefficients according to the shape of the decoding target block that is indirect control information.

For example, the blending unit 207 may be configured to select the weighting coefficients from among the plurality of weighting coefficients according to at least one of a short side of the decoding target block, a long side of the decoding target block, an aspect ratio of the decoding target block, a division mode, and the number of samples of the decoding target block.

For example, in a case where the short side of the decoding target block is used as the shape of the decoding target block, when the short side of the decoding target block is short, if weighted averaging is performed over a wide area, it is not different from simple bidirectional prediction. Therefore, it is desirable to exclude weighting coefficients of a pattern in which the width of the division boundary is wide from options.

For example, in the example of FIG. 3, the blending unit 207 selects the weighting coefficients of the pattern (3) in a case where the short side of the decoding target block is equal to or shorter than a threshold value, and selects the weighting coefficients of the pattern (2) in a case where the short side of the decoding target block is longer than the threshold value. Thus, it is possible to obtain an effect of increasing the number of patterns, eliminating a need for the control information of the pattern, and improving encoding efficiency.

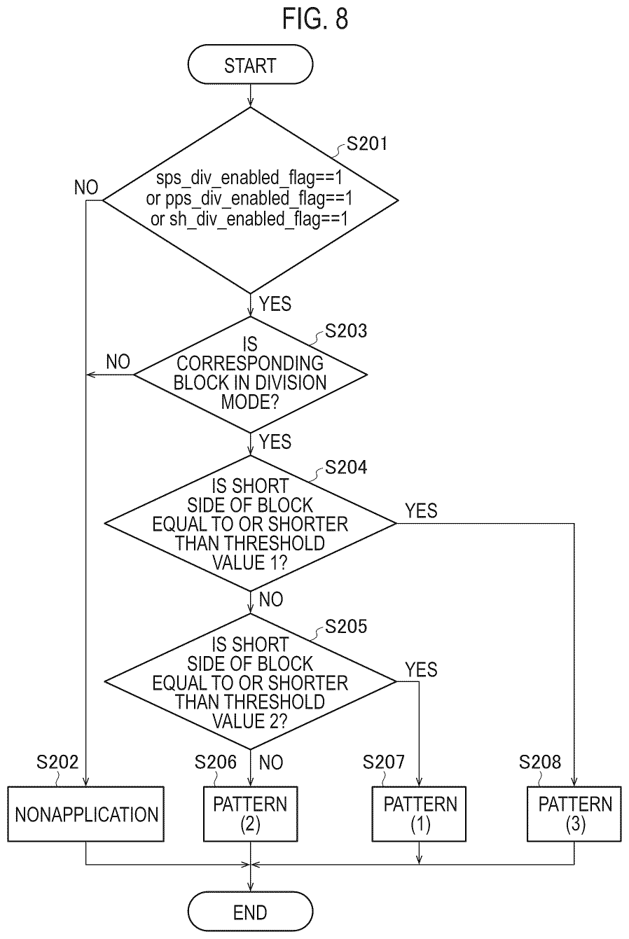

Hereinafter, an example of processing of setting the weighting coefficients by the blending unit 207 will be described with reference to FIG. 8.

As illustrated in FIG. 8, in step S201, the blending unit 207 determines whether or not any of sps_div_enabled_flag, pps_div_enabled_flag, and sh_div_enabled_flag included in the control information is 1. In a case of No (in a case where none of the flags is 1), the processing proceeds to step S202, and in a case of Yes, the processing proceeds to step S203.

In step S202, the blending unit 207 does not apply weighted averaging using the weighting coefficients to the decoding target block.

In step S203, the blending unit 207 determines whether or not GPM is applied to the decoding target block. In a case of No, the processing proceeds to step S202, and in a case of Yes, the processing proceeds to step S204.

In step S204, the blending unit 207 determines whether or not the short side of the decoding target block is equal to or shorter than a threshold value 1 that is set in advance. In a case of No, the processing proceeds to step S205, and in a case of Yes, the processing proceeds to step S208.

In step S205, the blending unit 207 determines whether or not the short side of the decoding target block is equal to or shorter than a threshold value 2 that is set in advance. Here, the threshold value 2 is larger than the threshold value 1. In a case of No, the processing proceeds to step S206, and in a case of Yes, the processing proceeds to step S207.

In step S206, the blending unit 207 selects and applies, as the weighting coefficients, the weighting coefficients of the pattern (2) from among the patterns (1) to (3).

In step S207, the blending unit 207 selects and applies, as the weighting coefficients, the weighting coefficients of the pattern (1) from among the patterns (1) to (3).

In step S208, the blending unit 207 selects and applies, as the weighting coefficients, the weighting coefficients of the pattern (3) from among the patterns (1) to (3).

Similarly, in a case where the long side of the decoding target block, the aspect ratio of the decoding target block, the division mode, the number of samples of the decoding target block, and the like are used as the shape of the decoding target block, if weighted averaging is performed over a wide area, it is not different from simple bidirectional prediction. Therefore, it is desirable to exclude weighting coefficients of a pattern in which the width of the division boundary is wide from the options.

That is, in step S204 and step S205 of the flowchart illustrated in FIG. 8, the short side of the decoding target block may be replaced with the long side of the decoding target block, the aspect ratio of the decoding target block, the division mode, or the number of samples of the decoding target block.

Further, in the flowchart illustrated in FIG. 8, in step S204, the blending unit 207 may determine whether or not the short side of the decoding target block is shorter than the threshold value 1 which is set in advance, and in step S205, the blending unit 207 may determine whether or not the short side of the decoding target block is shorter than the threshold value 2 which is set in advance.

Here, as the modified example, the short side of the decoding target block, the aspect ratio of the block, and the division mode (an angle of the division boundary) may be used as the shape of the decoding target block.

For example, in a case where the short side of the decoding target block is short, the aspect ratio of the block is large (height:width=4:1 or the like), and the angle of the division boundary is equal to or larger than 45 degrees, weighting coefficients of a pattern in which the width of the division boundary is wide may be excluded from the options.

Conversely, in a case where the short side of the decoding target block is short, the aspect ratio of the block is large (height:width=4:1 or the like), and the angle of the division boundary is smaller than 45 degrees, weighting coefficients of a pattern in which the width of the division boundary is narrow may be excluded from the options.

Thereby, it is possible to select the width of the division boundary in consideration of the shape of the block, and improvement in encoding performance can be expected.

Further, the blending unit 207 may be configured to select the weighting coefficients according to a motion vector.

Specifically, the blending unit 207 may be configured to use a motion vector of the small area and select the weighting coefficients according to a length of the motion vector of the small area or resolution of the motion vector of the small area.

As the motion vector is larger, the division boundary becomes more blurred. Therefore, it is desirable to widen the distribution of the weighting coefficients. Similarly, as the resolution of the motion vector is lower, the division boundary becomes more blurred. Therefore, it is desirable to widen the distribution of the weighting coefficients.

Further, the blending unit 207 may be configured to select the weighting coefficients according to a difference between the motion vectors of the small area A and the small area B.

Here, the difference between the motion vectors is a difference between reference frames of the motion vectors of the small area A and the small area B or an amount of a difference between the motion vectors themselves.

For example, the blending unit 207 may be configured to select the weighting coefficients so as to narrow the distribution of the weighting coefficients in a case where the difference between the motion vectors of the small area A and the small area B is equal to or larger than a predetermined threshold value (for example, one sample), and select the weighting coefficients so as to widen the distribution of the weighting coefficients in a case where the difference between the motion vectors of the small area A and the small area B is smaller than the predetermined threshold value (for example, one sample).

According to the configuration, it is possible to perform prediction with high accuracy in accordance with an edge of an image (a boundary between a background and a foreground having different movements, or the like) that may occur near the division boundary.

Alternatively, the blending unit 207 may be configured to select the weighting coefficients so as to widen the distribution of the weighting coefficients in a case where the difference between the motion vectors of the small area A and the small area B is equal to or larger than a predetermined threshold value (for example, one sample), and select the weighting coefficients so as to narrow the distribution of the weighting coefficients in a case where the difference between the motion vectors of the small area A and the small area B is smaller than the predetermined threshold value (for example, one sample).

According to the configuration, it is possible to perform prediction with high accuracy in accordance with a size of a motion blur in the vicinity of the division boundary.

Here, the blending unit 207 may be configured to select selectable weighting coefficients according to an angle relationship between the motion vector and the division boundary.

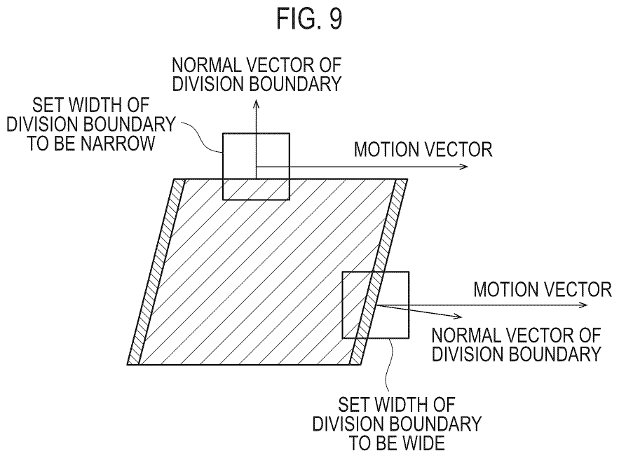

For example, as illustrated in FIG. 9, the blending unit 207 may be configured to select the weighting coefficients according to an absolute value |x×u+y×v| of the inner product of the motion vector (x, y) and the unit normal vector (u, v) of the division boundary.

Alternatively, the blending unit 207 may be configured to select selectable weighting coefficients according to an exposure time or a frame rate.

In a case where the exposure time is long or the frame rate is low, blurring is likely to occur. In a case where the exposure time is short or the frame rate is high, blurring is not likely to occur. Therefore, according to the configuration, an appropriate width can be selected.

For example, the blending unit 207 is configured to select a wide width 2 in the former case, and select a narrow width 3 in the latter case.

Further, the blending unit 207 may be configured to select selectable weighting coefficients according to a method of predicting the small area.

As the prediction method, intra prediction and motion compensation are assumed. Thus, according to the configuration, prediction accuracy can be improved by setting according to a characteristic of each prediction method.

Further, the blending unit 207 may be configured to select selectable weighting coefficients according to a quantized parameter.

As the quantized parameter has a larger value, the width is narrower and is relatively likely to be selected. Thus, according to the configuration, the prediction accuracy can be improved by adding the quantized parameter to the determination factor.

Further, the blending unit 207 may be configured to select the weighting coefficients of the decoding target block according to not only the control information of the decoding target block but also control information of a block near the decoding target block.

For example, the small area tends to be continuous across a plurality of blocks. Thus, the blending unit 207 may be configured to select the weighting coefficients of the decoding target block according to weighting coefficients of an adjacent decoded block.

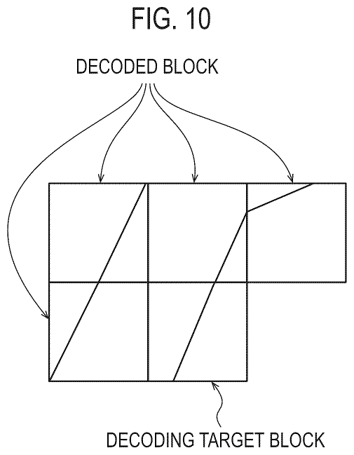

FIG. 10 is a diagram illustrating an example of left, upper left, upper, and upper right blocks adjacent to the decoding target block.

The division boundary also exists in the left and upper left blocks adjacent to the decoding target block, but is not continuous with the division boundary of the decoding target block. Therefore, the blending unit 207 does not select the noncontinuous division boundary, and can select, as the decoding target block, a width of the division boundary of the upper block of the decoding target block that has a continuous division boundary.

Similarly, the blending unit 207 may be configured to derive a pattern of weight coefficients of a block near the decoding target block, as an internal parameter corresponding to a merge index used when decoding the merge vector of each small area, and select the weight coefficients as the weight coefficients of each small area of the decoding target block.

The blending unit 207 may be configured to select the width of the division boundary of the pattern which is set in advance (for example, pattern (1)) as the small area of the decoding target block in a case where the merge vector corresponding to each small area does not exist.

Here, in a case where each small area is in the intra prediction mode, the blending unit 207 may be configured to select the width of the division boundary of the pattern which is set in advance (for example, pattern (1)) as the small area of the decoding target block.

According to these configurations, it is possible to improve prediction accuracy by taking over the width of the adjacent block having similar motions.

### Third Embodiment

Hereinafter, with reference to FIG. 3 and FIG. 8 to FIG. 11, a third embodiment of the present invention will be described focusing on differences from the first embodiment and the second embodiment.

In the present embodiment, the blending unit 207 is configured to generate the third predicted sample for at least one of the first predicted sample and the second predicted sample by weighted averaging using any one of the weighting coefficients limited based on the decoded control information.

That is, the blending unit 207 is configured to limit combinations of the selectable weighting coefficients according to the indirect control information and select the weighting coefficients to be applied based on the decoded control information from the limited combinations of the weighting coefficients.

Here, the blending unit 207 may be configured to prepare a plurality of weighting coefficients by which a width of the division boundary of the small areas is different and select the weighting coefficients.

The blending unit 207 may be configured to limit combinations of selectable weighting coefficients according to the shape of the decoding target block that is indirect control information.

For example, the blending unit 207 may be configured to limit the selectable weighting coefficients according to at least one of a size of the decoding target block (a short side of the decoding target block, a long side of the decoding target block, or the like), an aspect ratio of the decoding target block, a division mode, and the number of samples of the decoding target block.

Here, in a case where the short side of the decoding target block is used as the shape of the decoding target block, when the short side of the decoding target block is short, if weighted averaging is performed over a wide area, it is not different from simple bidirectional prediction. Therefore, it is desirable to exclude weighting coefficients of a pattern in which the width of the division boundary is wide from options (combinations of the selectable weighting coefficients).

For example, in the example of FIG. 3, the blending unit 207 limits combinations of the selectable weighting coefficients to the weighting coefficients of the pattern (1) or (3) in a case where the short side of the decoding target block is equal to or shorter than a threshold value, and limits combinations of the selectable weighting coefficients to the weighting coefficients of the pattern (1) or (2) in a case where the short side of the decoding target block is longer than the threshold value. Thus, it is possible to obtain an effect of increasing the number of patterns, reducing an encoding amount of the control information of the pattern, and improving encoding efficiency.

Here, for example, 8 samples or 16 samples may be set as the threshold value of the short side of the decoding target block.

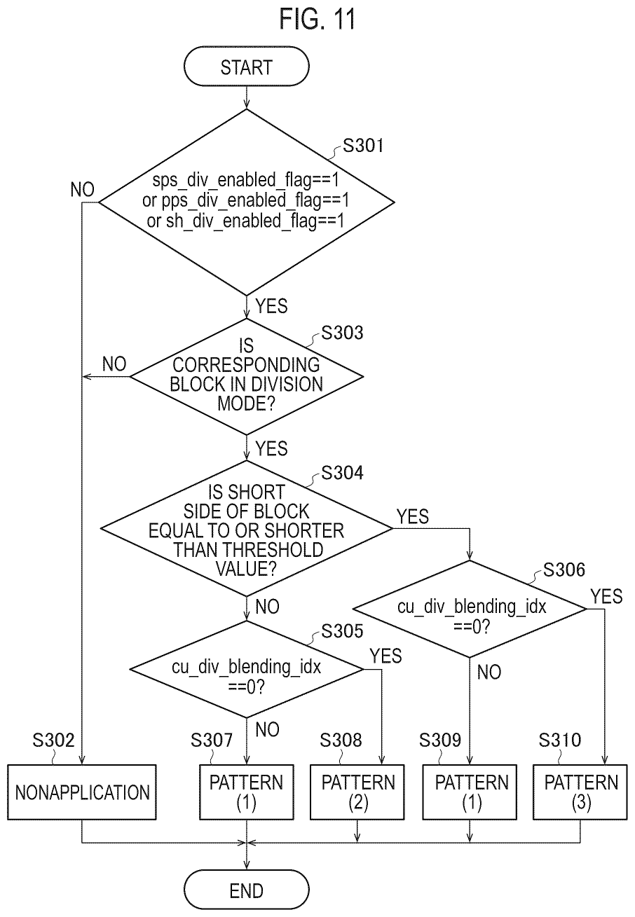

Hereinafter, an example of processing of setting the weighting coefficients by the blending unit 207 will be described with reference to FIG. 11.

As illustrated in FIG. 11, in step S301, the blending unit 207 determines whether or not any of sps_div_enabled_flag, pps_div_enabled_flag, and sh_div_enabled_flag included in the control information is 1. In a case of No (in a case where none of the flags is 1), the processing proceeds to step S302, and in a case of Yes, the processing proceeds to step S303.

In step S302, the blending unit 207 does not apply weighted averaging using the weighting coefficients to the decoding target block.

In step S303, the blending unit 207 determines whether or not GPM is applied to the decoding target block. In a case of No, the processing proceeds to step S302, and in a case of Yes, the processing proceeds to step S304.

In step S304, the blending unit 207 determines whether or not the short side of the decoding target block is equal to or shorter than a threshold value that is set in advance.

In a case of No, the processing proceeds to step S305, and in a case of Yes, the processing proceeds to step S306. Here, in a case of No, the blending unit 207 limits combinations of the selectable weight coefficients to the pattern (1) or (2), and in a case of Yes, the blending unit 207 limits combinations of the selectable weight coefficients to the pattern (1) or (3).

In step S305, the blending unit 207 decodes cu_div_blending_idx (direct control information) included in the control information.

In a case where cu_div_blending_idx is not 0, the present operation proceeds to step S307, and in a case where cu_div_blending_idx is 0, the present operation proceeds to step S308.

Similarly, in step S306, in a case where cu_div_blending_idx is not 0, the present operation proceeds to step S309, and in a case where cu_div_blending_idx is 0, the present operation proceeds to step S310.

In step S307, the blending unit 207 selects and applies, as the weighting coefficients, the weighting coefficients of the pattern (1) from the pattern (1) or (2).

In step S308, the blending unit 207 selects and applies, as the weighting coefficients, the weighting coefficients of the pattern (2) from the pattern (1) or (2).

In step S309, the blending unit 207 selects and applies, as the weighting coefficients, the weighting coefficients of the pattern (1) from the pattern (1) or (3).

In step S310, the blending unit 207 selects and applies, as the weighting coefficients, the weighting coefficients of the pattern (3) from the pattern (1) or (3).

Similarly, in a case where the long side of the decoding target block, the aspect ratio of the decoding target block, the division mode, the number of samples of the decoding target block, and the like are used as the shape of the decoding target block, if weighted averaging is performed over a wide area, it is not different from simple bidirectional prediction. Therefore, it is desirable to exclude weighting coefficients of a pattern in which the width of the division boundary is wide from the options.

That is, in step S304 of the flowchart illustrated in FIG. 11, the short side of the decoding target block may be replaced with the long side of the decoding target block, the aspect ratio of the decoding target block, the division mode, or the number of samples of the decoding target block.

Further, in the flowchart illustrated in FIG. 11, in step S304, the blending unit 207 may determine whether or not the short side of the decoding target block is shorter than a threshold value that is set in advance.

Here, as the modified example, the short side of the decoding target block, the aspect ratio of the block, and the division mode (an angle of the division boundary) may be used as the shape of the decoding target block.

For example, in a case where the short side of the decoding target block is short, the aspect ratio of the block is large (height:width=4:1 or the like), and the angle of the division boundary is equal to or larger than 45 degrees, weighting coefficients of a pattern in which the width of the division boundary is wide may be excluded from the options.

Conversely, in a case where the short side of the decoding target block is short, the aspect ratio of the block is large (height:width=4:1 or the like), and the angle of the division boundary is smaller than 45 degrees, weighting coefficients of a pattern in which the width of the division boundary is narrow may be excluded from the options.

Thereby, it is possible to select the width of the division boundary in consideration of the shape of the block, and improvement in encoding performance can be expected.

Further, the blending unit 207 may be configured to limit combinations of the selectable weighting coefficients according to the motion vector.

Specifically, the blending unit 207 may be configured to use a motion vector of the small area and limit combinations of the selectable weighting coefficients according to a length of the motion vector of the small area or resolution of the motion vector of the small area.

As the motion vector is larger, the division boundary becomes more blurred. Therefore, it is desirable to widen the distribution of the weighting coefficients. Similarly, as the resolution of the motion vector is lower, the division boundary becomes more blurred. Therefore, it is desirable to widen the distribution of the weighting coefficients.

Further, the blending unit 207 may be configured to limit combinations of the selectable weighting coefficients according to a difference between the motion vectors of the small area A and the small area B.

Here, the difference between the motion vectors is a difference between reference frames of the motion vectors of the small area A and the small area B or an amount of a difference between the motion vectors themselves.

For example, the blending unit 207 may be configured to limit combinations of the selectable weighting coefficients so as to narrow the distribution of the weighting coefficients in a case where the difference between the motion vectors of the small area A and the small area B is equal to or larger than a predetermined threshold value (for example, one sample), and limit combinations of the selectable weighting coefficients so as to widen the distribution of the weighting coefficients in a case where the difference between the motion vectors of the small area A and the small area B is smaller than the predetermined threshold value (for example, one sample).

According to the configuration, it is possible to perform prediction with high accuracy in accordance with an edge of an image (a boundary between a background and a foreground having different movements, or the like) that may occur near the division boundary.

Alternatively, the blending unit 207 may be configured to limit combinations of the selectable weighting coefficients of the pattern so as to widen the distribution of the weighting coefficients in a case where the difference between the motion vectors of the small area A and the small area B is equal to or larger than a predetermined threshold value (for example, one sample), and limit combinations of the selectable weighting coefficients of the pattern so as to narrow the distribution of the weighting coefficients in a case where the difference between the motion vectors of the small area A and the small area B is smaller than the predetermined threshold value (for example, one sample).

According to the configuration, it is possible to perform prediction with high accuracy in accordance with a size of a motion blur in the vicinity of the division boundary.

Here, the blending unit 207 may be configured to limit combinations of the selectable weighting coefficients according to an angle relationship between the motion vector and the division boundary.

For example, as illustrated in FIG. 9, the blending unit 207 may be configured to limit combinations of the selectable weighting coefficients according to an absolute value |x×u+y×v| of the inner product of the motion vector (x, y) and the unit normal vector (u, v) of the division boundary.

Alternatively, the blending unit 207 may be configured to limit the selectable weighting coefficients according to an exposure time or a frame rate.

In a case where the exposure time is long or the frame rate is low, blurring is likely to occur. In a case where the exposure time is short or the frame rate is high, blurring is not likely to occur. Therefore, according to the configuration, an appropriate width can be selected.

For example, the blending unit 207 is configured to select a wide width 2 in the former case, and select a narrow width 3 in the latter case.

Further, the blending unit 207 may be configured to limit combinations of the selectable weighting coefficients according to a method of predicting the small area.

As the prediction method, intra prediction and motion compensation are assumed. Thus, according to the configuration, prediction accuracy can be improved by setting according to a characteristic of each prediction method.

Further, the blending unit 207 may be configured to limit combinations of the selectable weighting coefficients according to a quantized parameter.

As the quantized parameter has a larger value, the width is narrower and is relatively likely to be selected. Thus, according to the configuration, the prediction accuracy can be improved by adding the quantized parameter to the determination factor.

Further, the blending unit 207 may be configured to limit combinations of the selectable weighting coefficients of the decoding target block according to not only the control information of the decoding target block but also control information of a block near the decoding target block.

For example, the small area tends to be continuous across a plurality of blocks. Thus, the blending unit 207 may be configured to limit combinations of the selectable weighting coefficients of the decoding target block according to weighting coefficients of an adjacent decoded block.

FIG. 10 is a diagram illustrating an example of left, upper left, upper, and upper right blocks adjacent to the decoding target block.

The division boundary also exists in the left and upper left blocks adjacent to the decoding target block, but is not continuous with the division boundary of the decoding target block. Thus, the noncontinuous division boundary is not included in combinations of the weighting coefficients of the decoding target block. Therefore, the blending unit 207 can include, in the combinations of the weighting coefficients of the decoding target block, a width of the division boundary of the upper block of the decoding target block that has a continuous division boundary.

Note that, when limiting the combinations of the selectable weight coefficients of the decoding target block, the blending unit 207 may be configured to limit the combinations in stages rather than limiting the choices to include or not include the combinations.

For example, the decoding unit 201 improves encoding efficiency by allocating different code lengths according to a selection probability of the weighting coefficients and decoding the block.

In the above example, the decoding unit 201 can set the pattern of the weight coefficients adopted by the adjacent decoded block as a short code length, and set the other pattern as a long code length.

Further, the image encoding device 100 and the image decoding device 200 may be realized as a program causing a computer to execute each function (each step).

According to the present embodiment, it is possible to improve the overall quality of service in video communications, thereby contributing to Goal 9 of the UN-led Sustainable Development Goals (SDGs) which is to “build resilient infrastructure, promote inclusive and sustainable industrialization and foster innovation”.

What is claimed is:

1. An image decoding device comprising a circuit, wherein
the circuit:
decodes control information and a quantized value;
obtains a decoded transform coefficient by performing inverse quantization on the decoded quantized value;
obtains a decoded prediction residual by performing inverse transform on the decoded transform coefficient;
generates a first predicted sample based on a decoded sample and the decoded control information;
accumulates the decoded sample;
generates a second predicted sample based on the accumulated decoded sample and the decoded control information;
generates a third predicted sample by weighted averaging using weighting coefficients which are uniquely selected from among a plurality of weighting coefficients based on indirect control information for at least one of the first predicted sample or the second predicted sample; and
obtains the decoded sample by adding the decoded prediction residual and the third predicted sample.

2. The image decoding device according to claim 1, wherein
the circuit prepares the plurality of weighting coefficients by which a width of a division boundary of a small area is different and selects the weighting coefficients.

3. The image decoding device according to claim 1, wherein
the circuit selects the weighting coefficients according to a shape of a decoding target block.

4. The image decoding device according to claim 3, wherein
the circuit selects the weighting coefficients according to at least one of a short side of the decoding target block, a long side of the decoding target block, an aspect ratio of the decoding target block, a division mode of the decoding target block, or the number of samples of the decoding target block.

5. The image decoding device according to claim 1, wherein
the circuit selects the weighting coefficients according to a motion vector.

6. The image decoding device according to claim 5, wherein
the circuit selects the weighting coefficients according to a length of a motion vector of a small area or resolution of the motion vector.

7. The image decoding device according to claim 5, wherein
the circuit specifies the selectable weighting coefficients according to an angle relationship between the motion vector and a division boundary.

8. The image decoding device according to claim 1, wherein
the circuit specifies the selectable weighting coefficients according to an exposure time or a frame rate.

9. The image decoding device according to claim 1, wherein
the circuit specifies the selectable weighting coefficients according to a method of predicting a small area.

10. The image decoding device according to claim 1, wherein
the circuit specifies the selectable weighting coefficients according to a quantized parameter.

11. The image decoding device according to claim 1, wherein
the circuit selects weighting coefficients of a decoding target block according to control information of a block near the decoding target block.

12. The image decoding device according to claim 11, wherein
the circuit selects the weighting coefficients of the decoding target block according to weighting coefficients of an adjacent decoded block.

13. The image decoding device according to claim 12, wherein
the circuit adopts a width of a division boundary of a block having a continuous division boundary, as the decoding target block.

14. The image decoding device according to claim 11, wherein
the circuit derives a pattern of weighting coefficients of the adjacent block as an internal parameter corresponding to a merge index used for decoding a merge vector of each small area, and selects the derived weighting coefficients as weighting coefficients of each small area of the decoding target block.

15. The image decoding device according to claim 14, wherein
in a case where the merge vector of each small area does not exist, the circuit adopts a width of a division boundary of a pattern which is set in advance, as the small area of the decoding target block.

16. The image decoding device according to claim 14, wherein
in a case where each small area is in an intra prediction mode, the circuit adopts a width of a division boundary of a pattern which is set in advance, as the small area of the decoding target block.

17. An image decoding method comprising:
decoding control information and a quantized value;
obtaining a decoded transform coefficient by performing inverse quantization on the decoded quantized value;
obtaining a decoded prediction residual by performing inverse transform on the decoded transform coefficient;
generating a first predicted sample based on a decoded sample and the decoded control information;
accumulating the decoded sample;
generating a second predicted sample based on the accumulated decoded sample and the decoded control information;
generating a third predicted sample by weighted averaging using weighting coefficients which are uniquely selected from among a plurality of weighting coefficients based on indirect control information for at least one of the first predicted sample or the second predicted sample; and
obtaining the decoded sample by adding the decoded prediction residual and the third predicted sample.

18. A program stored on a non-transitory computer-readable medium for causing a computer to function as an image decoding device including a circuit, wherein
the circuit:
decodes control information and a quantized value;
obtains a decoded transform coefficients by performing inverse quantization on the decoded quantized value;
obtains a decoded prediction residual by performing inverse transform on the decoded transform coefficient;
generates a first predicted sample based on a decoded sample and the decoded control information;
accumulates the decoded sample;
generates a second predicted sample based on the accumulated decoded sample and the decoded control information;
generates a third predicted sample by weighted averaging using weighting coefficients which are uniquely selected from among a plurality of weighting coefficients based on indirect control information for at least one of the first predicted sample or the second predicted sample; and
obtains the decoded sample by adding the decoded prediction residual and the third predicted sample.
